(19) United States
(12) Patent Application Publication
(10) Pub. No.: US 2007/0252728 A1
(43) Pub. Date: Nov. 1, 2007

(54) System and method for sensing and controlling the entry or exit of vehicles into or from a vehicle lot

(75) Inventors: David S. Wisherd, Carmel, CA (US); Timothy Harrington, Los Gatos, CA (US); Samuel Levy, Newton Upper Falls, MA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: WHERENET CORP, Corporation of the State of California, Santa Clara, CA (US)

(21) Appl. No.: 11/414,940

(22) Filed: May 1, 2006

(51) Int. Cl. G08G 1/01; G07B 15/00; G08B 13/14

(52) U.S. Cl. 340/933; 340/572.1; 705/13

(57) ABSTRACT

A system and method controls entry or exit of a vehicle to or from a vehicle lot. A tag transmitter is adapted to be mounted on a vehicle for transmitting a wireless RF signal that includes vehicle data relating to the vehicle. A lane sensor is associated with a vehicle lane through which vehicles pass for at least one of entering and exiting the vehicle lot and is configured to receive wireless RF signals from the tag transmitter when the vehicle is in the vehicle lane, while substantially rejecting wireless RF signals from other tag transmitters mounted on other vehicles within the vehicle lot or in an adjacent vehicle lane. A processor is operatively connected to the lane sensor and receives and processes the vehicle data to validate and control the vehicle's entry or exit to or from the vehicle lot.

### FIELD OF THE INVENTION

This invention relates to the field of sensors and real-time location systems (RTLS), and more particularly, this invention relates to sensing and controlling vehicles into and from a vehicle lot.

### BACKGROUND OF THE INVENTION

Many rental car lots and similar vehicle lots contain hundreds of cars and real-time data regarding the vehicles is often difficult to collect and maintain. Real-time data is necessary for validating a vehicle with a customer, and is especially important for controlling the exit of the vehicle from the rental car lot. Validation is also important when a vehicle car is returned.

Prior art rental car systems require excessive manual labor during the car rental process. More modern systems, however, are now using some type of automatic data collection system and user interface to aid in automated check-out and check-in at the rental car lots. For example, a customer could swipe a credit card at an exit kiosk having the user interface and validate the car rental. An exit gate could open automatically after validation. Still, many of these prior art systems require more manual labor than desired and add errors and time delays for a customer during the check-in and check-out process of the rental car.

### SUMMARY OF THE INVENTION

In accordance with a non-limiting example of the present invention, a system controls entry or exit of a vehicle to or from a vehicle lot. At least one vehicle lane is at the vehicle lot through which vehicles pass to at least one of enter or exit the vehicle lot. A tag transmitter is adapted to be mounted on a vehicle and transmits a wireless RF signal that includes vehicle data relating to the vehicle to which the tag transmitter is mounted. A lane sensor is associated at the vehicle lane and configured to receive wireless RF signals from the tag transmitter as the vehicle enters the vehicle lane, while substantially rejecting wireless RF signals from other tag transmitters mounted on other vehicles within the vehicle lot or in any adjacent vehicle lane. A processor is operatively connected to the lane sensor for receiving and processing the vehicle data to validate and control the vehicle's entry or exit to or from the vehicle lot.

In yet other non-limiting examples, the processor is operative for validating a customer by pairing a customer renting a vehicle with a vehicle identification as part of the vehicle data. A user interface can be positioned at the vehicle lane at which a vehicle operator interfaces for validating the vehicle as it enters or exits the vehicle lot. A reference tag transmitter can be positioned to emit wireless RF signals that are received at the lane sensor except when a vehicle has entered the vehicle lane indicative of a vehicle presence. The lane sensor could include a directional receiving antenna positioned at the vehicle lane that receives the wireless RF signals from a vehicle as it enters the vehicle lane. This directional receiving antenna can be configured to substantially reject any wireless RF signals from vehicles within any adjacent vehicle lanes and vehicles within the vehicle lot.

In yet other non-limiting examples, the transmitter tag can be operative for transmitting wireless RF signals upon detecting that the vehicle is in motion. The transmitter tag can be configured for connecting to an on-board diagnostic (OBD) system of a vehicle. The wireless RF signals could be formed as spread spectrum wireless signals.

In yet another aspect, a plurality of vehicle lanes are adjacent to each other through which the vehicles pass. A lane sensor is associated with each vehicle lane and includes a directional receiving antenna positioned at each vehicle lane that receives the wireless RF signals from the vehicle as it enters a respective lane and substantially rejects any wireless RF signals from vehicles within any other adjacent vehicle lanes and vehicles within the vehicle lot.

A system can also pair an asset and person for entry or exit to or from a physical space. At least one asset lane is included through which an asset passes to at least one of enter or exit the physical space. A tag transmitter is adapted to be mounted on the asset for transmitting a wireless RF signal that includes asset data relating to the asset to which the tag transmitter is mounted. A lane sensor is associated at the asset lane and configured to receive wireless RF signals from the tag transmitter as the asset enters the asset lane, while substantially rejecting wireless RF signals from other tag transmitters mounted on other assets within the physical space or any other adjacent asset lanes. A processor is operatively connected to the lane sensor and receives and processes the asset data and pairs a person with the asset and validates and controls the asset's entry or exit from the physical space.

A method aspect is also set forth.

### BRIEF DESCRIPTION OF THE DRAWINGS

Other objects, features and advantages of the present invention will become apparent from the detailed description of the invention, which follows when considered in light of the accompanying drawings in which:

FIG. 1 is a plan view of a portion of a vehicle lot and showing two vehicle lanes through which vehicles exit, and lane sensors positioned at each vehicle lane in accordance with non-limiting examples of the present invention.

FIG. 2 a top plan view of two vehicle lanes at a vehicle lot and showing a user interface and lane sensor at each vehicle lane.

FIG. 3 is an environmental view in perspective showing a vehicle and an elevated directional receiving antenna of a lane sensor positioned for sensing vehicles passing in that vehicle lane.

FIG. 4 is another top plan view similar to that view of FIG. 2 and showing a vehicle, the possible locations of vehicle tags, a lane sensor, user interface, and tag interrogators that could be used in accordance with non-limiting examples of the present invention.

FIG. 5 a block diagram showing a layout of detailed events that could occur for different vehicles located at a vehicle lot.

FIG. 6A is a general functional diagram of a tag transmitter that can be adapted for use in the system shown in FIGS. 1-5.

FIG. 6B is a schematic circuit diagram of an example of the circuit architecture of a tag transmitter as shown in FIG. 6A.

FIG. 7 is a high-level schematic circuit diagram showing basic components of an example of a circuit architecture that can be adapted for use as a receiver or access points operative with the tag transmitter and configured for use as a lane sensor.

FIG. 8 is a schematic circuit diagram of an example of a circuit architecture that can be modified for use as a processor and operative with a lane sensor and tag transmitter.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

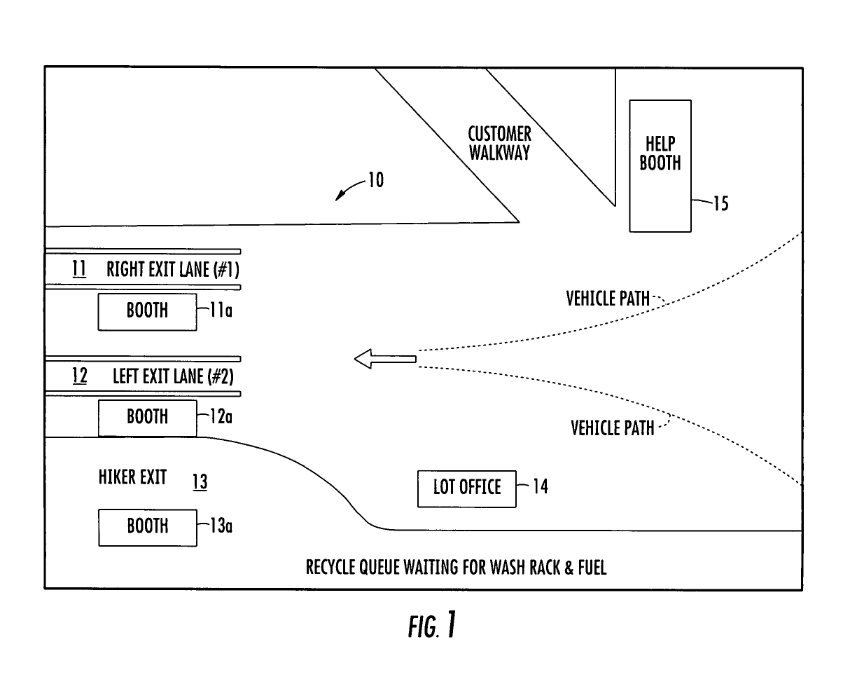

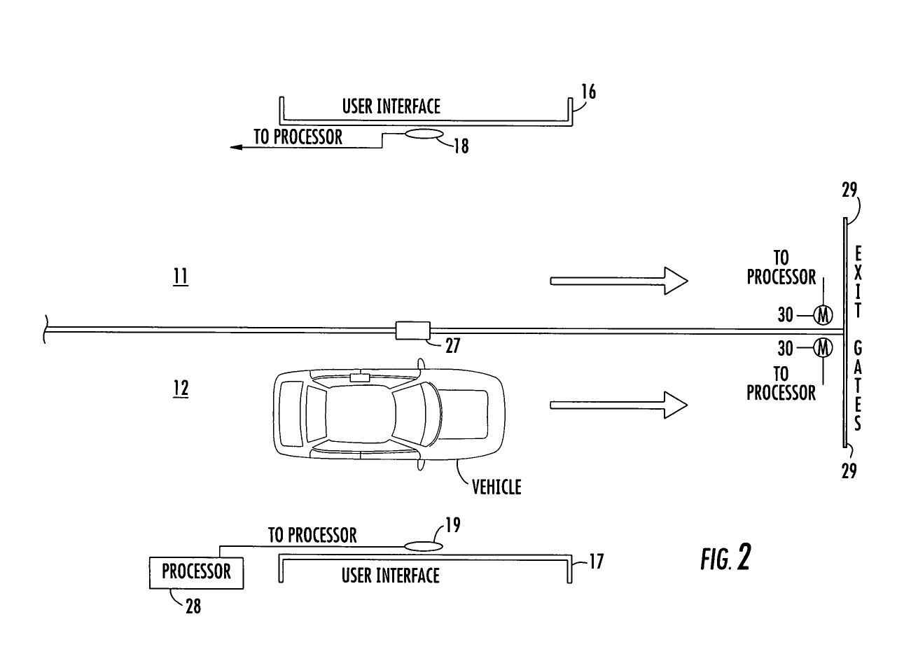

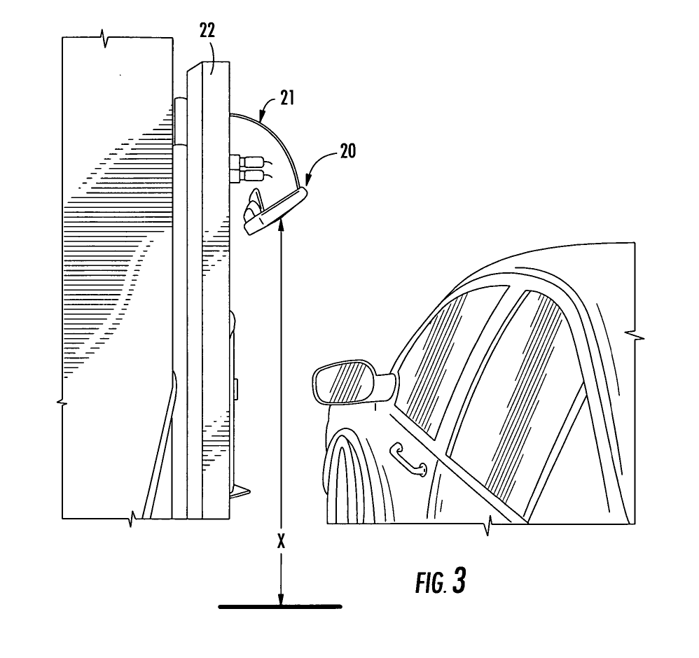

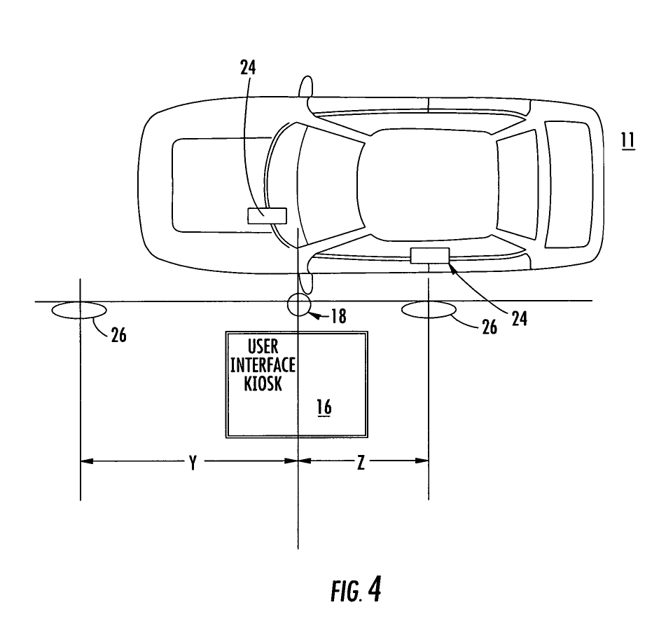

FIG. 1 is a plan view of a vehicle lot 10 as a rental car lot with two vehicle lanes 11,12 forming right and left exit lanes and a hiker exit 13. Each exit lane 11,12 and the hiker exit 13 include a booth 11a, 12a, 13a as is sometimes typical in similar commercial and private establishments. The vehicle lot 10 includes a lot office 14 and a help booth 15, and a customer walkway and two vehicle paths to the exit lanes as illustrated. FIG. 2 is a top plan view of the vehicle lot and vehicle lanes 11,12, showing a user interface 16,17 at each lane. Each user interface includes a respective lane sensor 18,19, although the lane sensors could be positioned in other locations besides at the user interface. An antenna 20 associated with each lane sensor and is co-located vertically and aligned with the driver's shoulder, as best shown in FIG. 3. The antenna footprint for the lane sensor is about 9 feet by about 8 feet in one non-limiting example. A vehicle is shown in a front adjacent lane of FIG. 4 corresponding to the second vehicle lane 12. The antenna 20 could be connected by a coaxial cable 21 to the main portion of the lane sensor containing various sensor circuits, which could be remote from the vehicle lane. The antenna could be integral with the overall lane sensor, however, and the coaxial cable 21 could be used to connect to a processor, as illustrated. The user interfaces 16,17 can interact with a vehicle operator for validating and controlling a vehicle as it enters or exits the vehicle lot.

FIG. 3 shows an antenna 20 configured as a directional receiving antenna and mounted on a pole 22 at a vehicle lane. In this one non-limiting example, the antenna is formed as a 60-degree beam circular polarized (CP) antenna aimed at a 45-degree downward angle. It connects with a double-shielded 50-ohm coaxial cable 21 to appropriate circuits, for example, the processor or to other portions of the lane sensor circuit, which could be adjacent or remote. The antenna can be mounted about five feet above ground level on a post as illustrated and adjacent the vehicle lane.

FIG. 4 is an enlarged plan view of a vehicle lane showing vehicle tag transmitter 24 mounted on the vehicle body and inside the vehicle, for example, connected to the on-board diagnostic (OBD) II system. Various tag interrogators 26 can be mounted at the vehicle lane 11 at an exit near the “kiosk” or user interface 16 and interrogate the vehicle tags as explained in grater detail below. The lane sensor 18 is shown at the user interface.

In accordance with a non-limiting example of the present invention, an RF transmitter tag 24 can be attached to the vehicle and transmit a continuous and repetitive, data packet stream of vehicle ID information when it detects vehicle motion, either from speedometer data on a vehicle data bus or by direct connection to vehicle motion sensors or the OBD system. The directional receiving antenna 20 detects the RF signals from the vehicle tag as it enters the user interface terminal 16 positioned for check-in or check-out. The directional receiving antenna 20 can be configured to reject signals from adjacent lanes and other vehicle occupied areas.

In accordance with another non-limiting example, a continuously transmitting RF reference tag 27 (FIG. 2) can be used as an enhancement feature and placed on the opposite side of the vehicle lane from the user interface. This reference tag is detectable at all times except when a vehicle is in the user interface position of the vehicle lane. The vehicle effectively blocks the RF signal from the reference tag to the lane sensor. This reference tag acts as a “vehicle in user interface terminal position” detector.

The processor 28 (FIG. 2) is operative as a computer-based information system and can process the RF tag data and validate a rental process and control the exit from and/or entry to a controlled area containing the vehicle, i.e., the vehicle lot. A customer could select either an assigned vehicle or any vehicle from an eligible pool depending on the type of rental process. At an automated exit gate 29, the vehicle identification and customer validation can be paired together to allow vehicle exit. At an entry gate (not shown), a similar process could be used. The processor 28 could control gate motors 30 as shown in FIG. 2 to permit a vehicle to exit the vehicle lot after validation.

Information data filters can also be incorporated with the processor 28 functions. For example, any vehicle, after being properly validated, can be blocked from a repeat lane detection for a predetermined time period. Each vehicle lane sensor, after a valid transaction, can reset and respond to the next vehicle tag transmitter it detects with a first-to-detect system. If two or more lane sensors detect a vehicle tag, all would then be reset to respond to a valid customer verification. Whichever lane has a valid transaction will generate a first-detect reset for all lanes currently holding that tag transmitter as valid. If there is more than one lane detection from the same tag transmitter, the lane whose tag transmitter is blocked, which indicates a vehicle presence on the tag transmitter, will be assigned a validation process if the other lane sensors that simultaneously detect the tag transmitter still are detecting their “beacon” or signal.

The lane sensor can detect ISO 24730 compliant vehicle tags at a 2.4 GHz RF transmit interface in one non-limiting example. The location sensor can have an RF receiver sensitivity that can be decreased by internal firmware change and external attenuator/cable loss by about 40 dB. This reduces the effective range of the lane sensor from a normal 1000 feet to about 9 feet. This allows detection discrimination of near capture lane over an adjacent far lane.

A vehicle tag transmitter can be configured to blink in a fast 4-second period, 8 sub-blink mode, when the vehicle is moving slowly, such as through the vehicle lot. These sub-blinks can be treated individually and separately for each of the lane sensor RF input channels. This allows independently tracking of separate vehicle lanes.

The lane sensor can use data available to it at the direct sensor level to produce two output results:

(1) a vehicle has been positively identified in a specific vehicle lane, i.e., the Output=ID and vehicle lane; and

(2) a vehicle has been positively identified but there is an ambiguity between possible vehicle lane locations which does not allow a specific vehicle lane to be assigned, i.e., the Output=ID and possible vehicle lanes (with weighting scores).

The following is an example of a performance specification in one non-limiting example:

Lateral capture range=6 feet;

Maximum vehicle window to antenna lateral range=2.5 feet (human reach); and

Data output accuracy.

It should be understood that the processor 28 is operative for validating a customer by pairing a customer renting a vehicle with a vehicle identification as part of the vehicle data. The RF signals can be formed as spread spectrum wireless signals.

It should also be understood that the system as described can be used in other environments besides a vehicle lot. The system can compare any type of asset and a person for entry or exit from a physical space. For example, an asset lane could be a conveyor or other transportation system that has at least one asset lane through which an asset passes for entering or exiting the physical space.

FIG. 3 shows an example elevation height of dimension X of about five feet in one non-limiting example. FIG. 4 shows dimensions Y and Z for positioning the interrogators 26, for example, about eight feet and four feet in non-limiting examples. The interrogators could be used to interrogate the tags to blink at a different rate such that the processor could identify even better a vehicle, since the interrogators would be limited in range and would only interrogate a tag transmitter that is in the vehicle lane near the interrogators. The interrogators could cause other functions to occur with a tag. When many different vehicles are operating within a vehicle lot and passing into and out of the vehicle lot through a plurality of different vehicle lanes, and with the appearance of many noise signals in the environment, the use of the reference tag and the use of interrogators would be advantageous. The interrogators can be designed as Whereport devices such as sold by the assignee, WhereNet, as described below. It is possible to have a dual lane sensor to cover one or more vehicle lanes.

An example of a single vehicle tag lane selection criteria is illustrated in the chart below:

SINGLE VEHICLE TAG LANE SELECTION CRITERIA

| Step# | Description | Criteria | Output | Fail Criteria | |
|---|---|---|---|---|---|
| 1 | Progress | 1 sub-blink | Start algorithm | N/A | |
| | Trigger | | & assign | | |
| | | | vehicle tag # | | |
| 2 | Select | 6 sub-blinks from same | Pass, go to | 1. | 10 second |
| | Primary Lane | lane | step #3 | | timeout |
| | | | Fail, go to | 2. | >3 sub-blink |
| | | | step #3 | | detects from |
| | | | | | other lane (s) |

| 3 | Accumulate | 5 second time window | | Pass, go to | Not > 2:1 total ratio of |
|---|---|---|---|---|---|
| | Data | | | step #4a | primary to-secondary |
| | | | | | detects |
| | | | | Fail, go to | |
| | | | | step #4b | |
| 4a | Declare | Pass #2 & #3 | | Validate Rental | |
| | Checkout | | | Process | |
| 4b | Declare | Fail #2 or #3 or both | | | |
| | Conflict | | | | |
| 5 | Resolve | 1. | Eliminate conflicted | | |
| | Conflict | | lanes if other vehicle | | |
| | | | checkout process is in | | |
| | | | progress | | |
| | | 2. | Wait 10 seconds for | Pass, Validate | No alternate |
| | | | alternate valid checkouts | rental Process | conflicted |
| | | | in conflicted lanes | | checkouts found |

Fail, Send
“Lane Conflict”
message

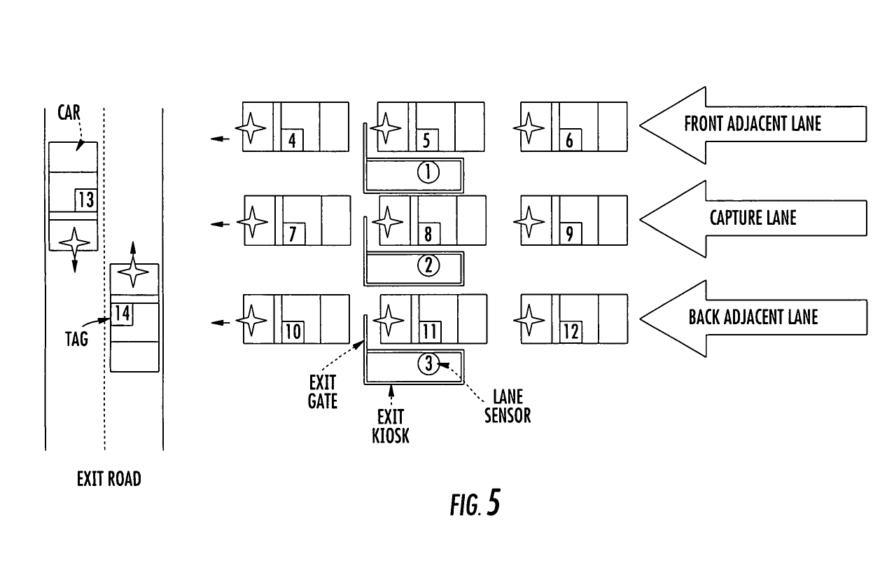

FIG. 5 shows an example that uses an exit road with two cars and tags positioned on the cars. The drawing also shows three adjacent vehicle lanes as a front adjacent lane, a capture lane and a back adjacent lane. An exit gate, and exit kiosk, and lane sensor are as illustrated.

The chart below indicates the event description and the automatic identification of a rental vehicle at a vehicle lot with the example of FIG. 5.

RENTAL CAR

| | |
|---|---|
| EVENT | AUTOMATIC IDENTIFICATION |
| DESCRIPTION | OF RENTAL CARS AT LOT |
| EVENT DATA | REAL-TIME ID OF CAR |
| REQUIREMENT | |

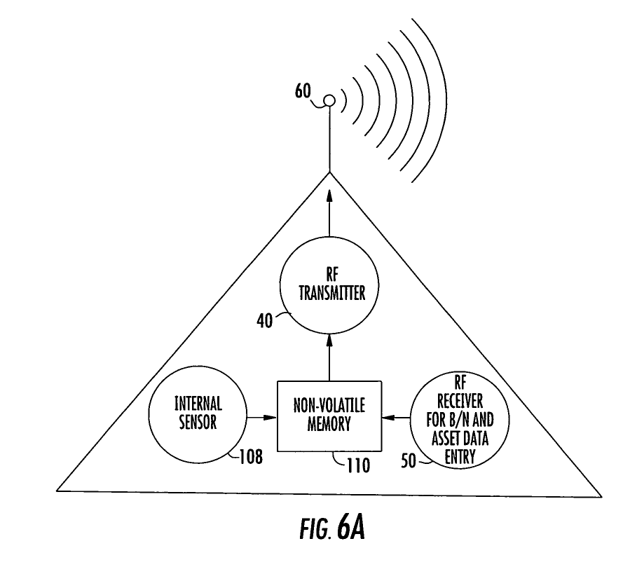

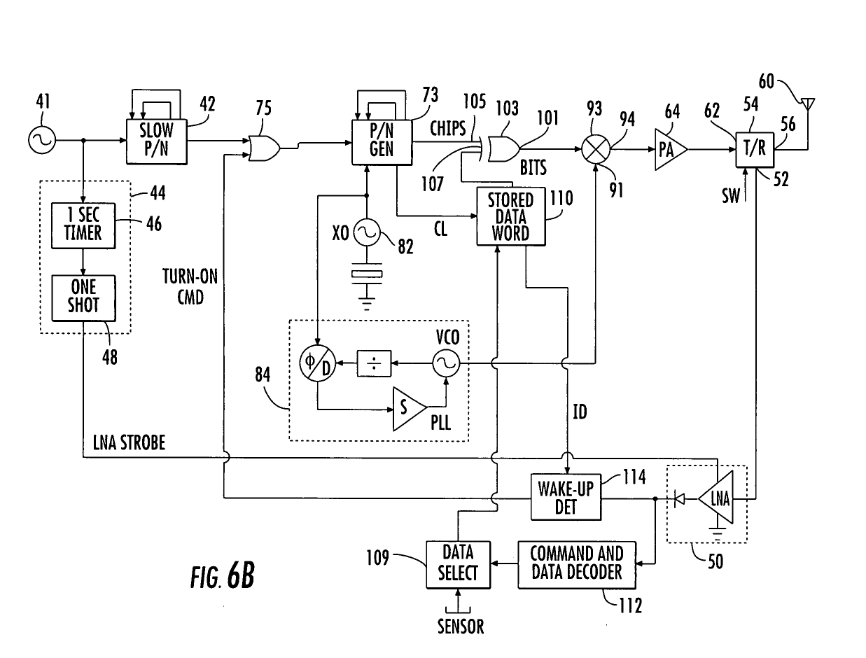

DETAILED EVENT LAYOUT DESCRIPTION (FIG. 6)

| | | DRAWING |
|---|---|---|
| | | REFERENCE |
| ELEMENT | DESCRIPTION | NUMBER'S |
| PRIMARY | EXIT KIOSK | 2 |
| ASSET | | |
| DEPENDANT | RENTAL CAR IN THE | 8 |
| ASSET | EXIT POSITION AT THE | |
| | KIOSK | |
| AUXILLARY | NONE | |
| ASSET | | |
| PRIMARY | LANE SENSORS | 1, 2, 3 |
| SENSOR | | |
| ASSOCIATE | ALL RENTAL CARS IN | 4 TO 14 |
| CANDIDATES | The AREA | |

ASSOCIATE CANDIDATE SELECTION RULES

| | | DRAWING |
|---|---|---|
| | | REFERENCE |
| RULE TYPE | DATA SOURCES | NUMBER'S |
| EVENT | GUARD (KEY STROKE) | 2 |
| TRIGGER | OR DRIVER (CARD | |
| (PREFERRED) | SWIPE) | |
| EVENT | A SINGLE AUTO-TAG | 2 |
| TRIGGER | BLINK DETECTION AT | |
| (NO-TOUCH) | The EXIT | |
| PROXIMITY | NUMBER OF AUTO-TAG | (1, 2, 3) & |
| | BLINKS DETECTED | (4 TO 14) |
| BEARING | N/A | |
| DATA | ALL AUTO-TAGS | |
| INCLUSION | DETECTED AT ALL EXIT | |
| | LANE SENSORS | |
| DATA | ALL TAGS DETECTED | 4, 7, 10, |
| EXCLUSION | THAT ARE IN-RENTAL | 13, 14 |
| | (CHECKED OUT) | |
| ASSET TYPE | DATA BASE RECORD OF | |
| | VEHICLES AVAILABLE | |
| | FOR RENTAL | |

For the proximity category with the associate candidate selection rules, there can be about a 10′ detect capture range to about a 30′ release (ducting) range.

The vehicle tag 24 can incorporate standard technology found in a WhereNet tag transmitters manufactured by WhereNet Corporation in Santa Clara, Calif. Examples are disclosed in the commonly assigned and incorporated by reference U.S. Pat. Nos. or published applications: 5,920,287; 5,995,046; 6,121,926; 6,127,976; 6,268,723; 6,317,082; 6,380,894; 6,434,194; 6,502,005; 6,593,885; 2002/0094012; 2002/0104879; and 2002/0135479.

The vehicle tag transmitter 24 can be operative similar to the tag as described in the above-identified issued patents and published patent applications. It can include a state machine to make the tag operative at different states, such as when the vehicle is moving or not moving. Throughout this description, it should be understood that the terms tag transmitter and tag are used interchangeably. The vehicle tag 24 can transmit or “blink” a short duration, wideband (spread spectrum) pulse of RF energy encoded with information received from an on-board diagnostic (OBD) system, and more particularly, a second generation system known as OBD-II. The vehicle tag can be operative at a rental car agency or similar vehicle lot, for example, fleet applications. The vehicle tag can include an oscillator, whose output is fed to a first “slow” pseudorandom pulse generator and to a strobe pulse generator or other circuitry as described in the incorporated by reference patents. It can include a timer and delay circuit and receiver circuitry. A high speed PN spreading sequence generator can be included with a crystal oscillator that provides a reference frequency for a phase locked loop (PLL) to establish a prescribed output frequency, for example, at 2.4 GHz. A mixer and output can be included with a vehicle tag memory that can include a database containing vehicle bus parameters as described in greater detail below.

The vehicle tag would not have to include a magnetic receiver as disclosed in some of the WhereNet assigned patents, but could include a microcontroller, an on-board diagnostic connector (tag connector), and at least one transceiver operative with the various vehicle protocols. A more simple tag transmitter could be used, of course. Basic components of a vehicle tag 24 that could be used are shown in commonly assigned U.S. Patent Publication No. 2004/0249557, the disclosure which is hereby incorporated by reference in its entirety.

The tag could include a housing base, a tag connector soldered to a printed circuit board and contained within the housing base, and a housing cover. The tag connector could be a J19620BD-II compatible connector for connection to OBD-II systems, but other tag connectors could be used depending on vehicle and/or OBD designs in use. An LED could be indicative of vehicle tag and visible through an LED opening in the cover operation and is mounted to the printed circuit board. The printed circuit board could include a microcontroller and any necessary transceivers and associated components. The microcontroller could communicate to the vehicle through the connector into the vehicle OBD-II system to gather telemetry information such as the mileage, fuel, speed, engine state and other parameters that make up the telemetry data. The system could transmit this information directly to a CMOS application specific integrated circuit (ASIC) of the vehicle tag, which causes the vehicle tag to blink out the telemetry in a manner similar to the blinking described in the above-identified patents.

The vehicle tag 24 could be derivative of the current WhereNet Wheretag III architecture as manufactured by WhereNet Corporation in Santa Clara, Calif. The vehicle tag could be a single assembly that contains the electronic components required for operation, including a vehicle bus interface, as a connector, the controller and transceiver as described before. In this configuration, the vehicle tag 24 could support the querying of a vehicle data bus for identification and diagnostic information. The vehicle tag will typically be used for buses conforming to the J1850 specification, but also could be compatible with the newly evolving CAN or other vehicle bus specifications.

The tag connector is compatible preferably with the J-1962 vehicle diagnostic jack that is typically located under a vehicle dash. The software used for the vehicle tag 24 can also be compatible with the Visibility Server Software Suite manufactured and sold by WhereNet Corporation, which is operable to accept, process, and forward data packets. A programming module can attach to a portable data terminal (PDT) to load vehicle parameters and firmware upgrades into the vehicle tag.

The vehicle tag 24 could include all functions of a current Wheretag III architecture and can interface to the vehicle bus, including J-1850, ISO-K, CAN and all variants, through the OBD diagnostic jack. It can read the vehicle identification number (VIN), odometer, fuel level, engine running, and/or diagnostic codes (DTC), but many of the functions may not be necessary. It can detect a disconnect to notify the system, even if it is disconnected while out of range. It can detect vehicle motion to the odometer or other circuits operating in a fast transmit mode. The vehicle tag is preferably powered by the vehicle electrical system through the diagnostic jack and into the OBD-II. It would typically be shipped from a factory in a non-blinking state to be triggered by a “connect” to a vehicle. A wired or wireless method and circuit can reprogram a flash memory for the microcontroller, using a handheld terminal with a programming module. The vehicle number, such as in the hardware and firmware, can be transmitted in a message at a reasonable rate. It is possible to detect key ON and motion to change state or being RF signals or “beacon” transmission.

The vehicle tag can be a single assembly that includes the tag connector and tag housing base and cover as one modular unit. Additional cable extensions could be used to connect to vehicles having an odd placement of jack. The vehicle tag could connect to the J-1962 connector. Input voltage can be a pass-through to provide power to the vehicle tag. Nominal voltage, for example, the SAE J1211, is 14.2 volts, running with 24-volt jump starts, and 4.5 volts during cold cranking. The vehicle tag can be a direct connect to a battery using fuses. SAEJ 1211, Section 14.11 defines the transience to which the tag can be designed. It can be sealed against dust and rain (IP 54) and operative at humidity levels of 5% to 99%. It can be designed for vibration specifications to SAE. It has 15 kilovolts through a 2.0K resistor from 300 of and allows “operating anomalies.” It preferably is designed for an operating temperature range of −30 degrees C. to +70 degrees C., and includes a storage temperature range of about −35 degrees C. to about +85 degrees C. It is compliant with requirements for CE certifications and “e” marked for use in EU counties. In one aspect of the present invention, the housing base and cover, in one example, is about 2.410 by 1.64 by 0.720 inches.

As to functionality, the RF components of the vehicle tag 24 have the same functionality as a WhereTag III device that is part of the WhereNet Real-Time Locating System (RTLS) as explained in the incorporated by reference patents. The vehicle tag 24 can operate in the globally accepted 2.4 GHz frequency band and transmit spread spectrum signals in excess of 300 meters outdoors, at less that 2 mW. It is operable with the Visibility Service Software that could be part of processor 28 software modules, such as offered by WhereNet Corporation, as an integrated software package, that allows management of assets and resources as well as the WhereNet Real-Time Locating System.

The Visibility Service Software is a distributed Windows service that can include configuration tools, diagnostics, system alerts, an interface manager, and installation tools. This software package allows for e-mail and paging notifications. SNMP MIB definition extensions can be included, allowing the RTLS system to be managed as part of an enterprise standard IT infrastructure. A software launcher can provide single point of entry and software modules for operation, administration, diagnostics, installation and documentation. Any administration modules can provide tools to allow configuration of the RTLS system to meet testing requirements. The vehicle tag 24, of course, is operable without any RTLS system and can be used at rental car agencies and close proximity and similar applications.

A user can configure who was notified by specific alerts and how they are notified. Diagnostic modules can contain the tools to allow monitoring of the health and status of any RTLS and monitor operation of any data acquisition module and tools to monitor the health and status of the physical hardware. Any installation and documentation modules are tools to be used during the installation and initial configuration of the system. Installation, operation and troubleshooting are included.

A proximity communication device or “interrogator” can be used in association with a vehicle tag of the present invention, and can be a WherePort device, such as manufactured by WhereNet Corporation. This device is used to trigger vehicle tags and transmit different “blink” patterns or originate other functions as described before.

The vehicle tag can be operative with the On-Board Diagnostic System, Generation II (OBD-II), which determines if a problem exists. OBD-II can have corresponding “diagnostic trouble codes” stored in the vehicle computer's memory, and a special lamp on the dashboard (called a malfunction indicator lamp (MIL)), which is illuminated when a problem is detected. Engines in newer vehicles are electronically controlled and sensors and actuators sense the operation of specific components, such as the oxygen sensor, and actuate others, such as fuel injectors, to maintain optimal engine control. A “power train control module” (PCM) or “engine control module” (ECM) controls the systems as an on-board computer, which monitors the sensors and actuators and determines if they are working as intended. The on-board computer detects malfunction or deterioration of the various sensors and actuators and can be addressed through the jack in which the vehicle tag of the present invention is connected.

The vehicle tag 24 can be operative with different vehicle tag electronics and OBD-II systems. The On-Board Diagnostics Phase II (OBD-II) has increased processing power, enhanced algorithms and improved control as compared to earlier generation systems. Different network standards are used. These include the J1850VPW used by GM (Class II) and Chrysler (J1850). The VPW (variable pulse width) mode is sometimes used with Toyota and Honda and is operative at 10.4 Kbps over a single wire. The J1850PWM has been used by Ford (Standard Corporate Protocol, SCP) and sometimes used by Mazda and Mitsubishi. SCP is 41.6 Kbps over a two wire balanced signal. ISO 9141 and ISO 9141-2 (ISO 9141 CARB) is sometimes used in Chrysler and Mazda products and more commonly used in Europe. It is operative at 10.4 Kbps over a single wire.

The network protocols are incompatible and describe physical and data link layers with the application layer used for specific messages. The vehicle tag 24 could include the requisite microcontroller and vehicle database and algorithms stored in vehicle tag memory to be operative with the different protocols. A controller area network (CAN) can address data link and application layers, but would not address physical layer or speed parameters. It is operative at high-speed (ISO 1898) and low speed (ISO 11519). A Class II GM implementation using the J1850VPW implementation and a single wire CAN and SCP have been used. The vehicle tag can be adapted for use with device net, J1939, J1708, a time triggered protocol (TTP), an ITS data bus, and PC type networks. The J1850VPW (variable pulse width) mode has symbols found in the J1850 specification, and operates at a nominal 10.4 Kbps. It uses a single wire with a ground reference and bus idle “low” as ground potential. The bus “high” is +7 volts and operative at +3.5 volts as a decision threshold, in one example. The bus “high” is dominant and has zero bits. Typically messages are limited to 12 bytes, including cyclical redundancy checks (CRC) and IFR bytes. It can use carrier sense multiple access with non-destructive arbitration (CSMA/NDA). A J1850 Pulse Width Modulation (PWM) has symbols defined in the J1850 specification and uses 41.6 Kbps. It can use a two wire differential signal that is ground referenced and a bus “high” as +5 volts, as a dominant state.

The vehicle tag 24 can also be operative with the ISO 9141-2 standard, which is UART based and operative at 10.4 Kbps. The K-line can be required as ground reference, and used for normal communications. An L-line can be ground referenced.

The vehicle tag can be designed to be easy to install and de-install, and can use 802.11 telemetry and location applications for fuel cost recovery and odometer verification, by transmitting data regarding the vehicle identification, the fuel and mileage. In rental car applications, it would improve customer experience for faster check-in and reduce labor costs and improve asset use. The vehicle tags 24 can be web-enabled.

As noted in the '586 patent, GPS can be used, and in the lane sensor system as described, GPS could be part of the lane sensors as a tag signal reader, and could also be operative as locating access points. Also, a port device as an interrogator (either separate or as part of a locating access point) can include circuitry operative to generate a rotating magnetic or similar electromagnetic or other field such that the port device is operative as a proximity communication device that can trigger a tag transmitter to transmit an alternate (blink) pattern. The port device acts as an interrogator, such as in the example of FIG. 4, and can be termed such. Such an interrogator is described in commonly assigned U.S. Pat. No. 6,812,839, the disclosure which is incorporated by reference in its entirety. When a tag transmitter passes through a port device field, the tag can initiate a pre-programmed and typically faster blink rate to allow the lane sensor and processor to know which vehicle or asset is present and in some location systems working with the system, allow more location points for tracking a tagged asset. Such tags, port devices, and Access Points are commonly sold under the trade designation WhereTag, WherePort and WhereLan by Wherenet USA headquartered in Santa Clara, Calif.

The system as described can also provide a wireless infrastructure for locating a particular vehicle on which the tag mounting device is temporarily mounted. A real-time location system provides real-time ID and location of tags, and provides reliable telemetry to record transactions, and provides mobile communications to work instruction and data entry terminals. Any terminal operating (management) software (TOS) can be optimized by real-time location and telemetry data to provide real-time, exact-slot accuracy of container ID and location, and real-time location and automatic telemetry of container transactions and container handling equipment and other mobile assets. The real-time location system is applicable for basic vehicle or asset inventory control.

The circuitry of a respective tag may be housed in a relatively compact, sealed transceiver module, which is sized to accommodate installation of a transceiver chip and one or more relatively long-life, flat-pack batteries and sensor devices. As a non-limiting example, the module may be rectangularly shaped, having a volume on the order of slightly more than one cubic inch, which allows the tag to be readily affixed to the temporary tag mounting device.

The general functional architecture of a tag can be formed as a transceiver (transmitter-transponder) unit, and used in the lane sensor system as described, and also used in any radio location and tracking system, which is either separate or a part of the lane sensor system. An example circuit is diagrammatically illustrated in FIG. 6A and the circuit components thereof are shown in detail in FIG. 6B, such as disclosed in the incorporated by reference '926 patent.

For sourcing signals to be transmitted by an RF transmitter section 40, the tag transceiver may comprise a relatively coarse oscillator 41, whose output is fed to a first “slow” pseudo random pulse generator 42 and to a strobe pulse generator 44 (FIG. 6B). As a non-limiting example, oscillator 41 may be implemented by means of a relatively inexpensive RC oscillator, which is sensitive to environmental parameter (e.g., temperature) variations and thus further minimizes the likelihood that any two tags will transmit simultaneously.

The strobe generator 44 includes a timer 46 having a prescribed time-out duration (e.g., one-second) and a (one-shot) delay circuit 48, the output of which is a low energy (e.g., several microamps) receiver enable pulse having a prescribed duration (e.g., one-second wide). This pulse is used to controllably enable or strobe a relatively short range receiver 50, such as a crystal video detector, which requires a very insubstantial amount of power compared to other components of the tag. Because the receiver enable pulse is very low power, it does not effectively affect the tag's battery life.

The duration of the receiver enable pulse produced by the strobe pulse generator 42 is defined to ensure that any low power interrogation or query signal generated by a transceiver, such as a battery-powered, portable interrogation unit will be detected by the crystal video receiver 50. As a relatively non-complex, low power device, crystal video receiver 50 is responsive to queries when the interrogating unit is relatively close to the tag (e.g., on the order of ten to fifteen feet). This prevents an interrogator (to be described) from stimulating responses from a large number of tags. Signal strength measurement circuitry within the interrogator may be used to provide an indication of the proximity of the queried tag relative to the location of the interrogator.

In order to receive interrogation signals from the interrogator, the receiver 50 has its input coupled to a receive port 52 of a transmit-receive switch 54, a bidirectional RF port 56 of which is coupled to an antenna 60. Transmit-receive switch 54 has a transmit port 62 thereof coupled to the output of an RF power amplifier 64, that is powered up only during the relatively infrequent transmit mode of operation of the tag, as will be described.

The output of the “slow” pseudo random pulse generator 42 is a series of relatively low repetition rate (for example, from tens of seconds to several hours) randomly occurring pulses or “blinks” that are coupled to a high speed PN spreading sequence generator 73 via an OR gate 75. These blinks/pulses define when the tag will randomly transmit or “blink” bursts of wideband (spread spectrum) RF energy to be detected by the lane sensors or other system readers used in the system, in order to locate and identify the tag using time-of-arrival geometry processing of the identified first-to-arrive signals, as described above when a location system is used.

In response to an enabling “blink” pulse, the high speed PN spreading sequence generator 73 generates a prescribed spreading sequence of PN chips. The PN spreading sequence generator 73 is driven at the RF frequency output of a crystal oscillator 82. This crystal oscillator provides a reference frequency for a phase locked loop (PLL) 84, which establishes a prescribed output frequency (for example a frequency of 2.4 GHz, to comply with FCC licensing rules). The RF output of the PLL 84 is coupled to a first input 91 of a mixer 93, the output 94 of which is coupled to the RF power amplifier 64. Mixer 93 has a second input 95 coupled to the output 101 of a spreading sequence modulation exclusive-OR gate 103. A first input 105 of exclusive-OR gate 101 is coupled to receive the PN spreading chip sequence generated by PN generator 73. A second input 107 of OR gate 101 is coupled to receive the respective bits of data stored in a tag data storage memory 110, which are clocked out by the PN spreading sequence generator 73.

As a non-limiting example, the tag memory 110 may comprise a relatively low power, electrically alterable CMOS memory circuit, which serves to store a multibit word or code representative of the identification of the tag. Memory circuit 110 may also store additional parameter data, such as that provided by an associated sensor (e.g., a temperature sensor) 108 that is installed on or external to the tag, and coupled thereto by way of a data select logic circuit 109. The data select logic circuit 109 is further coupled to receive data that is transmitted to the tag by means of an interrogation message from an interrogating unit, as decoded by a command and data decoder 112, which is coupled in circuit with the output of crystal video receiver 50.

The data select logic circuit 109 is preferably implemented in gate array logic and is operative to append any data received from a query or an external sensor to that already stored in memory 110. In addition, it may selectively couple sensor data to memory, so that the tag will send only previously stored data. It may also selectively filter or modify data output by the command and data decoder 112, as received from an interrogator.

When a query transmission from an interrogator is detected, the tag's identification code stored in memory 110 is coupled to a “wake-up” comparator 114. Comparator 114 compares the tag identification bit contents of a received interrogation message with the stored tag identification code. If the two codes match, indicating receipt of a wand query message to that particular tag, comparator 114 generates an output signal. This output signal is used to cause any data contained in a query message to be decoded by command and data decoder 112, and written into the tag memory 110 via data select logic circuit 109. The output of comparator 114 is coupled through OR gate 75 to the enable input of PN generator 73, so that the tag's transmitter will generate a response RF burst, in the same manner as it randomly and repeatedly ‘blinks’ a PN spreading sequence transmission containing its identification code and any parameter data stored in memory 110, as described above.

The tag transmitter can be mounted to different tag support members and can comply with ANSI 371.1 RTLS standard and can use a globally accepted 2.4 GHz frequency band, transmitting spread spectrum signals in accordance with the standard. The use of the spread spectrum technology can provide long-range communications in excess of 100 meters for read and a 300 meter locate range for outdoors. In the lane sensor application, that range is not as important as described before. This can be accomplished with less than two milliwatts of power. Battery life can be as long as seven years depending upon the blink rate, which could be user configurable from as little as five seconds to as much as one hour. Any type of activation from an interrogator can be up to six meters. The power could be a battery such as an AA lithium thionyl chloride cell. In one aspect, the height is about 0.9 inches and a length of about 2.6 inches or with mounting tags such as used for mounting the tag transmitter on the tag support member about four inches. The width is about 1.7 to about 2 inches.

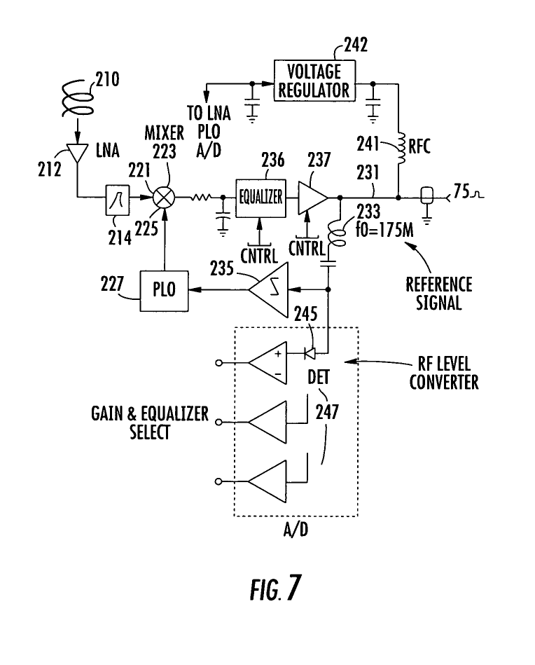

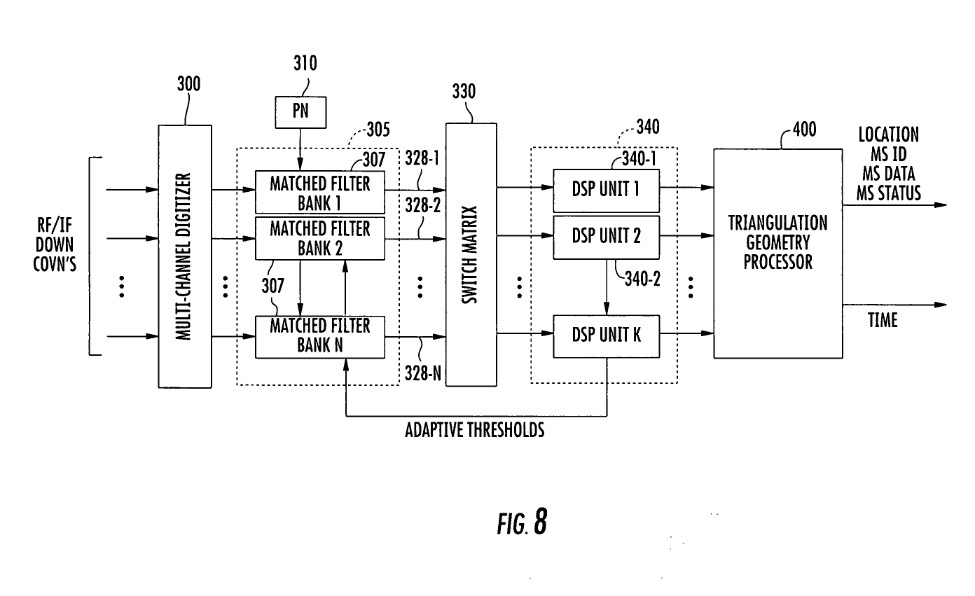

FIGS. 7 and 8 represent examples of the type of circuits that can be used with modifications as suggested by those skilled in the art for receiver circuitry as a lane sensor, also operative as an access point and processor circuitry as part of a server or separate unit to determine any timing matters, validate rentals or returns, set up a correlation algorithm responsive to any timing matters, determine which tag signals are first-to-arrive signals and conduct differentiation of first-to-arrive signals to locate a tag or other transmitter generating a tag or comparable signal.

Naturally, a more simple processor design could be used if only vehicle identification for validation and controlling entry and exit from a vehicle lot is desired.

Referring now to FIGS. 7 and 8, a representative circuit and algorithm as described in the above mentioned and incorporated by reference patents are disclosed and set forth in the description below to aid in understanding the type of receiver or access point and location processor circuitry that can be used for determining which signals are first-to-arrive signals and how a processor conducts differentiation of the first-to-arrive signals to locate a tag transmitter. These circuits would be beneficial if a location system is used in addition to the lane sensor system, but would not be necessary when only a lane sensor system is used.

FIG. 7 diagrammatically illustrates one type of circuitry configuration of a respective architecture for “reading” associated signals or a pulse (a “blink”) used for location determination signals, such as signals emitted from a tag transmitter to a receiver as a locating access point. An antenna 210 senses appended transmission bursts or other signals from the object and tag transmitter to be located. The antenna in this aspect of the invention could be omnidirectional and circularly polarized, and coupled to a power amplifier 212, whose output is filtered by a bandpass filter 214. Naturally, dual diversity antennae could be used or a single antenna. Respective I and Q channels of a bandpass filtered signal are processed in associated circuits corresponding to that coupled downstream of filter 214. To simplify the drawing only a single channel is shown.

A respective bandpass filtered I/Q channel is applied to a first input 221 of a down-converting mixer 223. Mixer 223 has a second input 225 coupled to receive the output of a phase-locked local IF oscillator 227. IF oscillator 227 is driven by a highly stable reference frequency signal (e.g., 175 MHz) coupled over a (75 ohm) communication cable 231 from a control processor. The reference frequency applied to phase-locked oscillator 227 is coupled through an LC filter 233 and limited via limiter 235.

The IF output of mixer 223, which may be on the order of 70 MHz, is coupled to a controlled equalizer 236, the output of which is applied through a controlled current amplifier 237 and preferably applied to communication cable 231 through a communication signal processor, which could be an associated processor. The communication cable 231 also supplies DC power for the various components of the access point by way of an RF choke 241 to a voltage regulator 242, which supplies the requisite DC voltage for powering an oscillator, power amplifier and analog-to-digital units of the receiver.

A 175 MHz reference frequency can be supplied by a communications control processor to the phase locked local oscillator 227 and its amplitude could imply the length of any communication cable 231 (if used). This magnitude information can be used as control inputs to equalizer 236 and current amplifier 237, so as to set gain and/or a desired value of equalization, that may be required to accommodate any length of any communication cables (if used). For this purpose, the magnitude of the reference frequency may be detected by a simple diode detector 245 and applied to respective inputs of a set of gain and equalization comparators shown at 247. The outputs of comparators are quantized to set the gain and/or equalization parameters.

It is possible that sometimes signals could be generated through the clocks used with the global positioning system receivers and/or other wireless signals. Such timing reference signals can be used as suggested by known skilled in the art.

FIG. 8 diagrammatically illustrates an example architecture of a correlation-based, RF signal processor circuit as part of a location processor to which the output of a respective RF/IF conversion circuit can be coupled such as by wireless communication (or wired in some instances) for processing the output and determining location based on the GPS receiver location information for various tag signal readers. The correlation-based RF signal processor correlates spread spectrum signals detected by an associated tag signal reader with successively delayed or offset in time (by a fraction of a chip) spread spectrum reference signal patterns, and determines which spread spectrum signal is the first-to-arrive corresponding to a location pulse.

Because each access point can be expected to receive multiple signals from the tag transmitter due to multipath effects caused by the signal transmitted by the tag transmitter being reflected off various objects/surfaces, the correlation scheme ensures identification of the first observable transmission, which is the only signal containing valid timing information from which a true determination can be made of the distance.

For this purpose, as shown in FIG. 8, the RF processor employs a front end, multichannel digitizer 300, such as a quadrature IF-baseband down-converter for each of an N number of receivers. The quadrature baseband signals are digitized by associated analog-to-digital converters (ADCs) 272I and 272Q. Digitizing (sampling) the outputs at baseband serves to minimize the sampling rate required for an individual channel, while also allowing a matched filter section 305, to which the respective channels (reader outputs) of the digitizer 300 are coupled to be implemented as a single, dedicated functionality ASIC, that is readily cascadable with other identical components to maximize performance and minimize cost.

This provides an advantage over bandpass filtering schemes, which require either higher sampling rates or more expensive analog-to-digital converters that are capable of directly sampling very high IF frequencies and large bandwidths. Implementing a bandpass filtering approach typically requires a second ASIC to provide an interface between the analog-to-digital converters and the correlators. In addition, baseband sampling requires only half the sampling rate per channel of bandpass filtering schemes.

The matched filter section 305 may contain a plurality of matched filter banks 307, each of which is comprised of a set of parallel correlators, such as described in the above identified, incorporated by reference '926 patent. A PN spreading code generator could produce a PN spreading code (identical to that produced by a PN spreading sequence generator of a tag transmitter). The PN spreading code produced by PN code generator is supplied to a first correlator unit and a series of delay units, outputs of which are coupled to respective ones of the remaining correlators. Each delay unit provides a delay equivalent to one-half a chip. Further details of the parallel correlation are found in the incorporated by reference '926 patent.

As a non-limiting example, the matched filter correlators may be sized and clocked to provide on the order of 4×10⁶ correlations per epoch. By continuously correlating all possible phases of the PN spreading code with an incoming signal, the correlation processing architecture effectively functions as a matched filter, continuously looking for a match between the reference spreading code sequence and the contents of the incoming signal. Each correlation output port 328 is compared with a prescribed threshold that is adaptively established by a set of “on-demand” or “as needed” digital processing units 340-1, 340-2, . . . 340-K. One of the correlator outputs 328 has a summation value exceeding the threshold in which the delayed version of the PN spreading sequence is effectively aligned (to within half a chip time) with the incoming signal.

This signal is applied to a switching matrix 330, which is operative to couple a “snapshot” of the data on the selected channel to a selected digital signal processing unit 340-1 of the set of digital signal processing units 340. The units can “blink” or transmit location pulses randomly, and can be statistically quantified, and thus, the number of potential simultaneous signals over a processor revisit time could determine the number of such “on-demand” digital signal processors required.

A processor would scan the raw data supplied to the matched filter and the initial time tag. The raw data is scanned at fractions of a chip rate using a separate matched filter as a co-processor to produce an auto-correlation in both the forward (in time) and backwards (in time) directions around the initial detection output for both the earliest (first observable path) detection and other buried signals. The output of the digital processor is the first path detection time, threshold information, and the amount of energy in the signal produced at each receiver's input, which is supplied to and processed by the time-of-arrival-based multi-lateration processor section 400.

Processor section 400 could use a standard multi-lateration algorithm that relies upon time-of-arrival inputs from at least three readers to compute the location of the tag transmitter. The algorithm may be one which uses a weighted average of the received signals. In addition to using the first observable signals to determine object location, the processor also can read any data read out of a memory for the tag transmitter and superimposed on the transmission. Object position and parameter data can be downloaded to a database where object information is maintained. Any data stored in a tag memory may be augmented by altimetry data supplied from a relatively inexpensive, commercially available altimeter circuit. Further details of such circuit are found in the incorporated by reference '926 patent.

It is also possible to use an enhanced circuit as shown in the incorporated by reference '926 patent to reduce multipath effects, by using dual antennae and providing spatial diversity-based mitigation of multipath signals. In such systems, the antennas are spaced apart from one another by a distance that is sufficient to minimize destructive multipath interference at both antennas simultaneously, and also ensure that the antennas are close enough to one another so as to not significantly affect the calculation of the location of the object by a downstream multi-lateration processor.

The multi-lateration algorithm executed by the location processor 26 could be modified to include a front end subroutine that selects the earlier-to-arrive outputs of each of the detectors as the value to be employed in a multi-lateration algorithm. A plurality of auxiliary “phased array” signal processing paths can be coupled to the antenna set (e.g., pair), in addition to any paths containing directly connected receivers and their associated first arrival detectors that feed the locator processor. Each respective auxiliary phased array path is configured to sum the energy received from the two antennas in a prescribed phase relationship, with the energy sum being coupled to associated units that feed a processor as a triangulation processor.

The purpose of a phased array modification is to address the situation in a multipath environment where a relatively “early” signal may be canceled by an equal and opposite signal arriving from a different direction. It is also possible to take advantage of an array factor of a plurality of antennas to provide a reasonable probability of effectively ignoring the destructively interfering energy. A phased array provides each site with the ability to differentiate between received signals, by using the “pattern” or spatial distribution of gain to receive one incoming signal and ignore the other.

The multi-lateration algorithm executed by the location processor 26 could include a front end subroutine that selects the earliest-to-arrive output of its input signal processing paths and those from each of the signal processing paths as the value to be employed in the multi-lateration algorithm (for that receiver site). The number of elements and paths, and the gain and the phase shift values (weighting coefficients) may vary depending upon the application.

It is also possible to partition and distribute the processing load by using a distributed data processing architecture as described in the incorporated by reference '976 patent. This architecture can be configured to distribute the workload over a plurality of interconnected information handling and processing subsystems. Distributing the processing load enables fault tolerance through dynamic reallocation.

The front end processing subsystem can be partitioned into a plurality of detection processors, so that data processing operations are distributed among sets of processors. The partitioned processors are coupled in turn through distributed association processors to multiple location processors. For tag detection capability, each reader could be equipped with a low cost omnidirectional antenna, that provides hemispherical coverage within the monitored environment.

A detection processor filters received energy to determine the earliest time-of-arrival energy received for a transmission, and thereby minimize multi-path effects on the eventually determined location of a tag transmitter. The detection processor demodulates and time stamps all received energy that is correlated to known spreading codes of the transmission, so as to associate a received location pulse with only one tag transmitter. It then assembles this information into a message packet and transmits the packet as a detection report over a communication framework to one of the partitioned set of association processors, and then de-allocates the detection report.

A detection processor to association control processor flow control mechanism equitably distributes the computational load among the available association processors, while assuring that all receptions of a single location pulse transmission, whether they come from one or multiple detection processors, are directed to the same association processor.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A system for controlling entry or exit of a vehicle to or from a vehicle lot, comprising:
at least one vehicle lane through which vehicles pass for at least one of entering and exiting the vehicle lot;
a tag transmitter adapted to be mounted on a vehicle for transmitting a wireless RF signal that includes vehicle data relating to the vehicle to which the tag transmitter is mounted;
a lane sensor associated with the vehicle lane and configured to receive wireless RF signals from the tag transmitter as the vehicle enters the vehicle lane while substantially rejecting wireless RF signals from other tag transmitters mounted on other vehicles within the vehicle lot or in any adjacent vehicle lane; and
a processor operatively connected to said lane sensor for receiving and processing the vehicle data to validate and control the vehicle's entry or exit to or from the vehicle lot.

2. A system according to claim 1, wherein said processor is operative for validating a customer by pairing a customer renting a vehicle with a vehicle identification as part of the vehicle data.

3. A system according to claim 1, and further comprising a user interface positioned at the vehicle lane at which a vehicle operator interfaces for validating the vehicle as it enters or exits the vehicle lot.

4. A system according to claim 1, and further comprising a reference tag transmitter positioned to emit wireless RF signals that are received at the lane sensor except when a vehicle has entered the vehicle lane indicative of a vehicle presence.

5. A system according to claim 1, wherein said lane sensor includes a directional receiving antenna positioned at the vehicle lane that receives the wireless RF signals from a vehicle as it enters the vehicle lane.

6. A system according to claim 5, wherein said directional receiving antenna is configured to substantially reject any wireless RF signals from vehicles within any adjacent vehicle lanes and within the vehicle lot.

7. A system according to claim 1, wherein said transmitter tag is operative for transmitting wireless RF signals upon detecting that the vehicle is in motion.

8. A system according to claim 1, wherein said transmitter tag is configured for connecting to an on-board diagnostic (OBD) system of a vehicle.

9. A system according to claim 1, wherein said wireless RF signals comprise spread spectrum wireless signals.

10. A system for controlling entry or exit of a vehicle to or from a vehicle lot, comprising:
a plurality of vehicle lanes adjacent to each other through which vehicles pass for at least one of entering and exiting the vehicle lot;
a tag transmitter adapted to be mounted on a vehicle for transmitting a wireless RF signal that includes vehicle data relating to the vehicle to which the tag transmitter is mounted;
a lane sensor associated with each vehicle lane and comprising a directional receiving antenna positioned at each vehicle lane that receives the wireless RF signals from a vehicle as it enters a respective lane and substantially reject any wireless RF signals from vehicles within any other adjacent vehicle lanes and vehicles within the vehicle lot or in any adjacent vehicle lane; and
a processor operatively connected to each lane sensor for receiving and processing the vehicle data to validate and control a vehicle's entry or exit to or from the vehicle lot.

11. A system according to claim 10, wherein said processor is operative for validating a customer by pairing a customer renting a vehicle with a vehicle identification as part of the vehicle data.

12. A system according to claim 10, and further comprising a user interface positioned at each vehicle lane at which a vehicle operator interfaces for validating the vehicle as it enters or exits the vehicle lot.

13. A system according to claim 10, and further comprising a reference tag transmitter positioned to emit wireless RF signals that are received at a lane sensor except when a vehicle has entered a vehicle lane indicative of a vehicle presence.

14. A system according to claim 10, wherein said transmitter tag is operative for transmitting wireless RF signals upon detecting that the vehicle is in motion.

15. A system according to claim 10, wherein said transmitter tag is configured for connecting to an on-board diagnostic (OBD) system of a vehicle.

16. A system according to claim 10, wherein said wireless RF signals comprise spread spectrum wireless signals.

17. A system for pairing an asset and person for entry or exit to or from a physical space, comprising:
at least one asset lane through which an asset passes for at least one of entering and exiting the physical space;
a tag transmitter adapted to be mounted on the asset for transmitting a wireless RF signal that includes asset data relating to the asset to which the tag transmitter is mounted;
a lane sensor associated with the asset lane and configured to receive wireless RF signals from the tag transmitter as the asset enters the asset lane while substantially rejecting wireless RF signals from other tag transmitters mounted on other assets within the physical space or any other adjacent asset lanes; and
a processor operatively connected to said lane sensor for receiving and processing the asset data and pairing a person with the asset and validating and controlling the asset entry or exit from the physical space.

18. A method for controlling entry or exit of a vehicle to or from a vehicle lot, which comprises:
transmitting a wireless RF signal from a tag transmitter mounted on a vehicle, wherein the RF signal includes vehicle data relating to the vehicle to which the tag transmitter is mounted;
driving the vehicle into a vehicle lane to enter or exit to or from the vehicle lot;
receiving the wireless RF signals from the tag transmitter at a lane sensor associated with the vehicle lane when the vehicle is in the vehicle lane, while substantially rejecting wireless RF signals from other tag transmitters mounted on other vehicles within the vehicle lot or positioned in adjacent vehicle lanes; and
processing the vehicle data within a processor operatively connected to the lane sensor to validate and control the vehicle's entry or exit from the vehicle lot.

19. A method according to claim 18, which further comprises validating a customer by pairing a customer renting a vehicle with a vehicle identification as part of the vehicle data.

20. A method according to claim 18, which further comprises emitting wireless RF signals from a reference tag transmitter that is received at the lane sensor except when a vehicle has entered the vehicle lane indicative of a vehicle presence.

21. A method according to claim 19, which further comprises receiving the wireless RF signals within a directional receiving antenna as a vehicle enters a vehicle lane.

22. A method according to claim 19, which further comprises configuring the directional receiving antenna for substantially rejecting any wireless RF signals from vehicles within any adjacent vehicle lanes and vehicles within the vehicle lot.

23. A method according to claim 19, which further comprises initiating the transmission of the wireless RF signals from the transmitter tag after detecting that a vehicle is in motion.

24. A method according to claim 19, which further comprises connecting the transmitter tag to an on-board diagnostic (OBD) system of a vehicle.
